(19) United States
(12) Patent Application Publication
(10) Pub. No.: US 2025/0147775 A1
(43) Pub. Date: May 8, 2025

(54) AUTOMOTIVE ELECTRONIC CONTROL UNIT AND A METHOD FOR IMPROVING READ/WRITE PERFORMANCE OF A CONFIGURATION FILE WITH A KEY-VALUE STRUCTURE

(71) Applicant: HYUNDAI AUTOEVER CORP., Seoul (KR)

(72) Inventor: Keon Woo Lee, Seoul (KR)

(73) Assignee: HYUNDAI AUTOEVER CORP., Seoul (KR)

(21) Appl. No.: 18/930,554

(22) Filed: Oct. 29, 2024

(30) Foreign Application Priority Data
Nov. 8, 2023 (KR) 10-2023-0153802

(51) Int. Cl. G06F 9/445

(52) U.S. Cl. CPC G06F 9/44505

(57) ABSTRACT

An automotive electronic control unit includes an application configured to flatten a nested structure of a first configuration file in which keys-values are recorded in a nested structure. The application is also configured to substitute the flattened keys with symbols recorded in a schema table. The application is further configured to record the symbols in a second configuration file. The application is additionally configured to search for a key-value in the second configuration. The automotive electronic control unit also includes a memory configured to store the schema table and the second configuration file.

### CROSS REFERENCE TO RELATED APPLICATION

This application claims the benefit of and priority to Korea Patent Application No. 10-2023-0153802, filed on Nov. 8, 2023, the entire disclosure of which is hereby incorporated herein by reference in its entirety.

### FIELD OF TECHNOLOGY

The present disclosure relates to an automotive electronic control unit.

### BACKGROUND

As modern technologies and innovations are applied to modern automobiles, various electronic control units are incorporated in automobiles to control and monitor numerous functions. Such electronic control units are designed for enhancing the safety, convenience, fuel efficiency, and driving experience of vehicles. Generally, each unit manages a specific operation and system. For example, an engine control unit optimizes the fuel efficiency and adjusts engine performance and a safety control unit supervises an airbag system and brake control. In addition, a vehicle includes various other units, such as an entertainment control unit to manage an infotainment system and a driving assistance system control unit to control an advanced driver assistance system for reinforcing the driving safety. All these units smoothly interact with each other to provide drivers and passengers with excellent vehicle experiences.

Electronic control units utilize configuration files in order to elaborately control and monitor operations. A configuration file is a kind of a ‘manifest’ file that includes various configuration information required for interactions of an electronic control unit with various systems and components. An electronic control unit optimizes the performance, safety, convenience, and efficiency of a vehicle using such configuration information.

For example, an electronic control unit may verify configuration information for engine controls and adjusts engine operating parameters, such as the fuel injection amount, air intake amount, valve timing, etc. The electronic control unit may also read brake control configurations to adjust the brake pressure and operations of the antilock brake system (ABS), and may manage operations of airbags and the traction control system based on safety control configurations. Entertainment system configuration information is for managing various functions of an audio, video, and navigation systems and driving assistance system configurations are for tuning an advanced driver assistance system related to lane keeping assist, cruise control, automatic parking, etc.

As such, using configuration files, an electronic control unit adjusts and optimizes various aspects of a vehicle to provide drivers and passengers with safe and convenient vehicle experiences. Since accuracy and calibration of configuration information greatly affect the performance and efficiency of a vehicle, the accuracy and calibration of configuration information are considered as one of important parts in engineering and software development.

A configuration file is often formed in a key-value structure that is usually used for classifying and storing configuration information. However, there are some cases where an electronic control unit processes a very big configuration file and, in such cases, the overhead that occurs for verifying data in a key-value form may greatly stand out.

The overhead stands out more as the size of a configuration file increases and the number of key-value pairs increases. In particular, when configuration information is stored in a nested structure, i.e., when different pairs of keys-values are nested in a single key, the overhead increases further. Such a case requires more time for searches and interpretations of configuration information and uses more memory.

The discussions in this section are intended merely to provide background information and do not constitute an admission of prior art.

### SUMMARY

In an aspect, embodiments of the present disclosure provide a technology for reducing overhead of an electronic control unit and enhancing the performance of the electronic control unit. In another aspect, embodiments of the present disclosure provide a technology for enhancing the read/write performance of a configuration file storing keys-values in a nested structure.

According to an embodiment of the present disclosure, an automotive electronic control unit is provided. The automotive electronic control unit includes an application configured to flatten a nested structure of a first configuration file in which keys-values are recorded in a nested structure. The application is also configured to substitute flattened keys with symbols recorded in a schema table and record the symbols in a second configuration file. The application is further configured to search for a key-value in the second configuration file. The automotive electronic control unit also includes a memory to store the schema table and the second configuration file.

In the first configuration file and the second configuration file, keys-values may be expressed and recorded in JavaScript Object Notation (JSON).

In the first configuration file, keys-values may be recorded by being nested in the depth of N (N is a natural number equal to or higher than 2) and, in the second configuration file, keys-values may be recorded in a single level.

In the schema table, matching relations between some or all of keys recorded in the first configuration file and the symbols may be defined.

The symbols may have the data size less than that of the keys recorded in the first configuration file.

The first configuration file may be a manifest file.

According to an embodiment of the present disclosure, an automotive electronic control unit is provided. The automotive electronic control unit includes a configuration module configured to flatten a nested structure of a first configuration file in which keys-values are recorded in a nested structure and to substitute flattened keys with symbols recorded in a schema table to record the symbols in a second configuration file. The automotive electronic control unit also includes a main module to perform a specific function and to change values of data stored in a random access memory (RAM) in accordance with the performance of the function. The automotive electronic control unit further includes a persistency module to search for a key-value for one piece of data among the data in the second configuration file and to store the one piece of data in a flash memory based on a searched value.

In the second configuration file, at least one of a sector number, the size, and a checksum value of the flash memory, where the one piece of data is stored, may be stored in a key-value structure.

In the second configuration file, keys-values may be recorded in a single level.

The persistency module may store the one piece of data in the flash memory before power is turned off.

The persistency module may periodically store the one piece of data in the flash memory.

The size of a file, obtained by flattening a nested structure of the first configuration file, may be bigger than the size of the first configuration file and the size of the first configuration file may be bigger than the size of the second configuration file.

The first configuration file may have a form of a manifest file.

According to an embodiment of the present disclosure, an automotive electronic control method is provided. The automotive electronic control method includes flattening a nested structure of a first configuration file in which keys-values are recorded in a nested structure. The automotive electronic control method also includes substituting flattened keys with symbols recorded in a schema table and recording the symbols in a second configuration file. The automotive electronic control method additionally includes searching for keys-values in the second configuration file.

Searching for keys-values in the second configuration file may include searching for a key-value for one piece of data, among data stored in a random access memory (RAM), in the second configuration file and storing the one piece of data in a flash memory based on a searched value.

The electronic control method may further include generating a signal to indicate power off before storing the one piece of data in a flash memory based on a searched value.

The electronic control method may further include periodically generating signals by a timer before storing the one piece of data in a flash memory based on a searched value.

In the first configuration file and the second configuration file, keys-values may be expressed and recorded in JavaScript Object Notation (JSON).

In the first configuration file, keys-values may be recorded by being nested in the depth of N (N is a natural number equal to or higher than 2) and, in the second configuration file, keys-values may be recorded in a single level.

In the second configuration file, at least one of a sector number, the size, and a checksum value of the flash memory, where the one piece of data is stored, may be stored in a key-value structure.

As described above, embodiments of the present disclosure allow reducing overhead of an electronic control unit and improving the performance of an electronic control unit. The present disclosure also allows enhancing the read/write performance of a configuration file storing keys-values in a nested structure.

### BRIEF DESCRIPTION OF THE DRAWINGS

In order that the disclosure may be well understood, there are now described various forms thereof, given by way of example, reference being made to the accompanying drawings, in which:

FIG. 1 is a first configuration diagram of an electronic control unit according to an embodiment;

FIG. 2 is a second configuration diagram of an electronic control unit according to an embodiment;

FIG. 3 is a diagram illustrating that an application according to an embodiment flattens a nested structure of a first configuration file;

FIG. 4 is a diagram of a schema table according to an embodiment;

FIG. 5 is a diagram illustrating that an application according to an embodiment generates a second configuration file using a schema table;

FIG. 6 is a flow diagram of an electronic control method according to an embodiment;

FIG. 7 is a third configuration diagram of an electronic control unit according to an embodiment;

FIG. 8 is a diagram of a first configuration file according to an embodiment; and

FIG. 9 is a diagram showing a process of storing data in a flash memory when power is turned off.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order not to obscure the gist of the present disclosure.

In addition, terms, such as “1st”, “2nd”, “A”, “B”, “(a)”, “(b)”, or the like, may be used in describing the components of the present disclosure. These terms are intended only to distinguish a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

When a component, device, module, element, or the like of the present disclosure is described as having a purpose or performing an operation, function, or the like, the component, device, or element should be considered herein as being “configured to” meet that purpose or perform that operation or function.

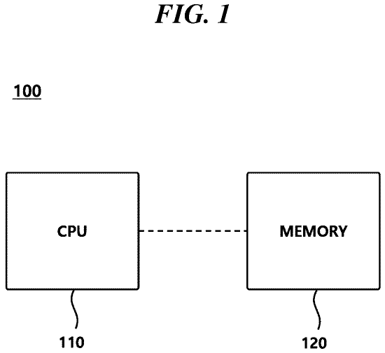

FIG. 1 is a first configuration diagram of an electronic control unit according to an embodiment.

Referring to FIG. 1, an electronic control unit 100 may comprise a central processing unit (CPU) 110 and a memory 120.

The CPU 110, which may also be referred to as a microprocessor, is a central control unit to conduct main processing operations. The CPU 110 includes sets of complicated commands and processing functions, and may manipulate a vehicle system by executing such commands.

The electronic control unit 100 may have a multiple core structure. In this case, the electronic control unit 100 includes at least two CPUs 110 to enable simultaneously processing multiple operations and to enable parallel processing, thereby providing rapid data processing and response time.

The CPU 110 includes an input-output interface to communicate with various sensors and actuators and to be connected with external devices. Through the interface, data exchange and communication between a vehicle system and external systems are possible.

The CPU 110 uses an on-chip cache for rapid data access. This cache may store frequently used data and commands to enhance the performance of repetitive operations.

The CPU 110 may store and process data using a memory such as a random access memory (RAM). Such a memory may be used for temporarily storing software in execution and data required for operations.

The memory 120 may include a flash memory, a random access memory (RAM), an Electrically Erasable Programmable Read-Only Memory (EEPROM), a Read-Only Memory (ROM), or the like.

A flash memory may be used mainly for storing program codes and software data stored in an electronic control unit 100. A vehicle manufacturer may use a flash memory for updating or modifying software of an electronic control unit 100. A flash memory is a non-volatile memory where data is conserved when power is off.

A RAM is a working memory that a CPU 110 uses during operation. It may be used for temporarily storing and processing data. A RAM may store variables required during execution of a program, stacked data, intermediate results, etc. Since data is lost in a RAM when power is off, a RAM may be mainly used for temporarily storing data.

An EEPROM is a non-volatile memory like a flash memory. However, an EEPROM requires more power to read and write data. An EEPROM may be mainly used for storing configuration information and/or special data. For example, it may be utilized for vehicle configurations, key programming, error code logging, etc.

A ROM is a read-only memory that may be used for storing initial program codes and firmware. Unchangeable data and commands are stored in a ROM and the commands may be executed when an electronic control unit 100 is booted. A ROM may define basic operations of a vehicle and support core functions of an electronic control unit 100.

An application may be implemented according to operations of a CPU 110 and a memory 120. Codes of an application may be stored in a flash memory or a ROM. Codes may be read and be executed by a CPU 110 in a single command unit.

A CPU 110 traces the address of a command to be subsequently executed using a register called ‘a program counter’. The command may be loaded in a memory 120 and stored and executed in an instruction register of the CPU 110.

An application may read or write data using a memory such as a RAM or an EEPROM. A RAM may be mainly used to store and manipulate data during execution of an application. Data may be accessed through a memory address and a CPU 110 may use a memory address to load and store data.

Hereinafter, operations by an application may be understood as operations by hardware such as a CPU 110 or a memory 120 as described above.

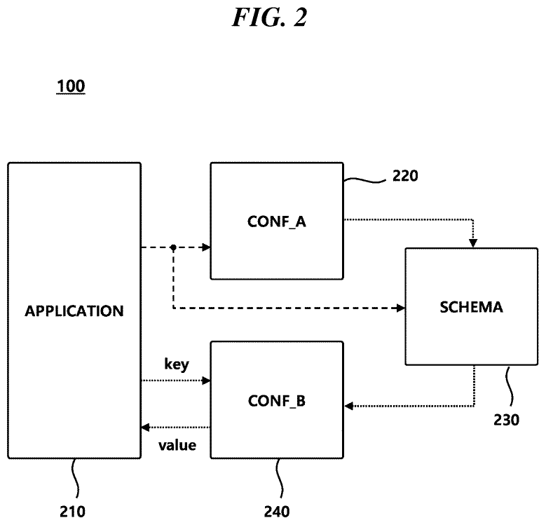

FIG. 2 is a second configuration diagram of an electronic control unit according to an embodiment.

Referring to FIG. 2, the electronic control unit 100 may include an application 210, a first configuration file 220, a second configuration file 240, a schema table 230, etc. The first configuration file 220, the second configuration file 240, and the schema table 230 may be stored in a memory.

In the first configuration file 220, keys-values may be recorded in a nested structure.

The first configuration file 220 may be a manifest file. A manifest file used in an electronic control unit (ECU) of an automobile may be a file mainly to define information and configurations of software and hardware components. Such a manifest file may include important meta data regarding which version of software each electronic control unit in an automobile executes and which hardware each electronic control unit interacts with.

The application 210 may flatten a nested structure in the first configuration file 220.

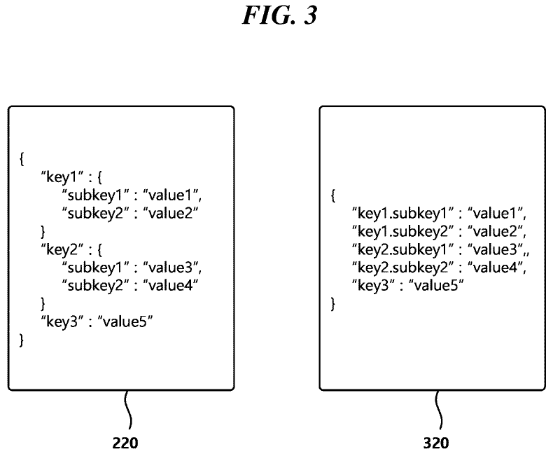

FIG. 3 is a diagram illustrating that an application according to an embodiment flattens a nested structure of a first configuration file.

Referring to FIG. 3, in the first configuration file 220, keys-values may be recorded in a nested structure.

In the first configuration file 220, a structure in which key-value pairs are nested may be used for expressing a complicated composition. Such a nested structure generally has a form similar to that of a tree or a nested map, and may efficiently express various configurations and compositions. Various configuration file formats, such as JavaScript Object Notation (JSON), eXtensible Markup Language (XML), etc., may use a key-value structure.

For example, in the first configuration file 220, keys-values may be expressed and recorded using JSON as shown in FIG. 3.

A JavaScript Object Notation (JSON) is a light text-based format used as a data exchange format. A JSON provides a simple and structured format to store and transmit data and is mainly used for data communication.

In the JSON, data is expressed using key-value pairs. A key is formed of a character string and a value may be expressed by various data format (character string, number, Boolean, object, array, null). A key and a value are divided by a colon (:) and key-value pairs are divided by commas (,).

A JSON object is a set of key-value pairs enclosed by curly brackets ({ }). A key must be unique and a key-value pair must be unique in an object.

A JSON array is a list of values enclosed by square brackets ([ ]). In an array, there is an order of values and the values are divided by commas. An array may include various data types, and may also include objects or other arrays.

In the example of FIG. 3, configurations of key1 and key2 are nested. The configuration of key1 includes subkey1 and subkey2 and has a key-value nested structure and the configuration of key2 includes subkey 1 and subkey2 and has a key-value nested structure. On the contrary, in the example of FIG. 3, a configuration of key3 does not have a nested structure.

Using a nested structure enables logically grouping configurations and composing the configurations in a meaningful way and a nested structure is useful to handle complicated configuration requirements. A program or an application may read configuration files with a nested structure, extract required values, and designate configurations and operations defined by a user.

However, such a nested structure may decrease the read/write performance of a configuration file. Accordingly, an application according to an embodiment may flatten a nested structure of the first configuration file 220.

The application may disassemble key-value pairs with a nested structure to convert them into key-value pairs with a single level in a JSON file of a nested structure such as the first configuration file 220. Through this process, data result in being expressed in a simpler and flatter form.

First, the application may create an empty object. This object may be used for storing a flattened result. The application may extract key-value pairs by circulating in a given JSON file. Here, the key-value pairs may be found inside nested structures and arrays.

Then, the application may combine keys while flattening nested objects. The application may create a new key by combining a key in a nested object with a key in a superior object.

Flattening key-value pairs under “key1”:

“key1.subkey1” → “value1”
“key1.subkey2” → “value2”

Flattening key-value pairs under “key2”:

“key2.subkey1” → “value3”
“key2.subkey2” → “value4”

The application may add all the key-value pairs to a new object to create a flattened configuration file 320 shown in FIG. 3.

Referring again to FIG. 2, the application 210 may substitute flattened keys with symbols recorded in the schema table 230 and may record the symbols in the second configuration file 240. The application 210 may then search for keys-values in the second configuration file to use them.

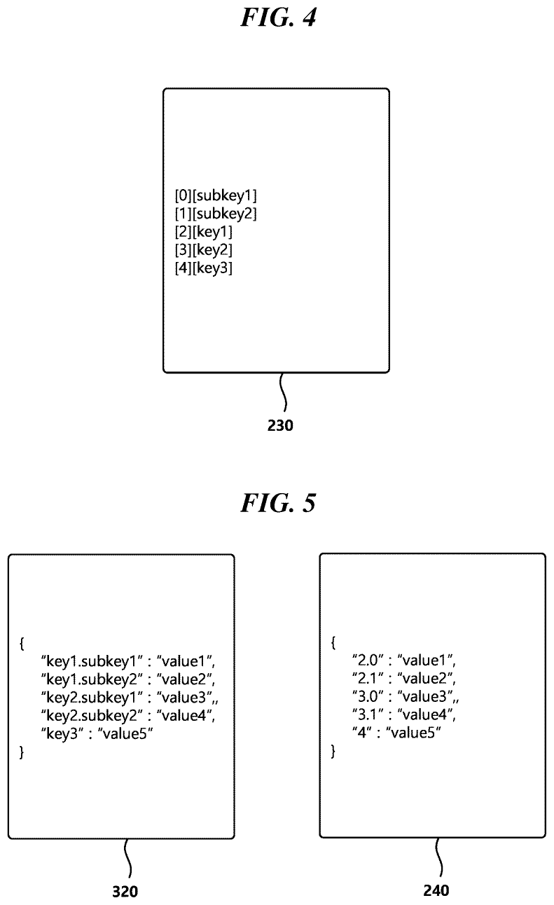

FIG. 4 is a diagram of a schema table according to an embodiment. FIG. 5 is a diagram illustrating that an application according to an embodiment generates a second configuration file using a schema table.

Referring to FIGS. 4 and 5, the application stores the schema table 230. The application may convert the form of the flattened configuration file 320 into the form of the second configuration file 240 using the schema table 230 and may store the second configuration file 240.

A schema table is one of components to define a method for structuring and storing data in a database or a data storage. Such a table describes specific structures of data and plays an important role when querying or processing data in a database or a data storage.

In the schema table 230, matching relations between some or all of keys recorded in the first configuration file and symbols may be defined. Here, symbols may have smaller data size than the keys recorded in the first configuration file.

In an example in FIG. 4, [0][subkey1] describes a first element in the schema table and defines a matching relation between the symbol ‘0’ and the key ‘subkey1’. [1][subkey2] describes a second element in the schema table and defines a matching relation between the symbol ‘1’ and the key ‘subkey2’. [2][key1] describes a third element in the schema table and defines a matching relation between the symbol ‘2’ and the key ‘key1’. [3][key2] describes a fourth element in the schema table and defines a matching relation between the symbol ‘3’ and the key ‘key2’. [4][key3] describes a fifth element in the schema table and defines a matching relation between the symbol ‘4’ and the key ‘key3’.

The application may reconstruct data based on information of the schema table 230 in order to convert the flattened configuration file 320 with a JSON structure into the second configuration file 240 with a JSON structure.

The application may first take column names from the schema table 230 to construct keys of the second configuration file 240.

“key1.subkey1” → “2.0”
“key1.subkey2” → “2.1”
“key2.subkey1” → “3.0”
“key2.subkey2” → “3.1”
“key3” → “4”

Then, the application takes values corresponding to the relevant keys from the flattened configuration file 320.

“key1.subkey1” → “value1”
“key1.subkey2” → “value2”
“key2.subkey1” → “value3”
“key2.subkey2” → “value4”
“key3” → “value5”

The application may complete the second configuration file 240 by combining such information.

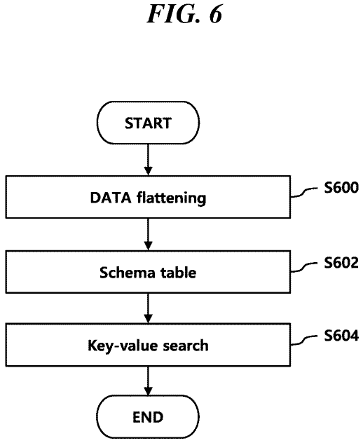

FIG. 6 is a flow diagram of an electronic control method according to an embodiment.

Referring to FIG. 6, the electronic control unit may flatten a nested structure of the first configuration file in which keys-values are recorded in a nested structure in an operation or step S600.

The electronic control unit may substitute flattened keys with symbols recorded in the schema table and may record them in the second configuration file in an operation or step S602.

The electronic control unit may search for keys-values in the second configuration file and may use them in an operation or step S604.

When searching for and using keys-values, the electronic control unit may search for a key-value for one piece of data, among data stored in a random access memory (RAM), in the second configuration file and may store the one piece of data in a flash memory based on a searched value. In the second configuration file, at least one of a sector number, the size, and a checksum value of the flash memory, where the one piece of data is stored, may be stored in a key-value structure.

This process may be performed when power is turned off. The electronic control unit may recognize generation of a signal indicating the power-off and may store the one piece of data in the flash memory based on a searched value. Time allowed for the generation of a signal indicating the power-off and the storage of data in the flash memory based on the searched data may be short. In order to perform such a process in a short time, the electronic control unit may flatten the first configuration, simplify the same using the schema table, and store it as the second configuration file. The second configuration file, that is obtained by flattening and has a small data size, may shorten read/write time of the electronic control unit.

The aforementioned process may be performed whenever signals are periodically generated by a timer. The electronic control unit may recognize the periodic generation of signals by a timer and may store one piece of data in the flash memory based on a searched value. When such signals by a timer are generated with a short period, there might be a lot of load on reading/writing configuration files by the electronic control unit. In order to perform such a process with small load, the electronic control unit may flatten the first configuration file, simplify the same using the schema table, and store it as the second configuration file. The second configuration file, that is obtained by flattening and has a small data size, may reduce the load of the reading/writing of the electronic control unit. Since keys-values may be recorded in the first configuration file in the depth of N (N is a natural number equal to or higher than 2), but keys-values are recorded in a single level in the second configuration file, the reading/writing load of the electronic control unit may be reduced.

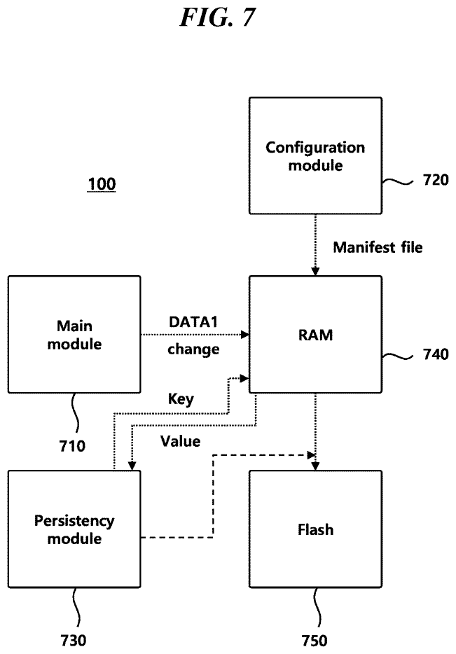

FIG. 7 is a third configuration diagram of an electronic control unit according to an embodiment.

Referring to FIG. 7, the electronic control unit 100 may include a main module 710, a configuration module 720, a persistency module 730. The electronic control unit 100 may also include a random access memory (RAM) 740 and a flash memory 750.

The main module 710 may perform a specific function and may change values of data DATA1 stored in the RAM 740 according to the performance of such a function.

The configuration module 720 may flatten a nested structure of a first configuration file, where keys-values are recorded in a nested structure, substitute flattened keys with symbols recorded in the schema table, and record the symbols in a second configuration file.

In the second configuration file, at least one of a sector number, the size, and a checksum value of the flash memory 750, where data is stored, may be stored in a key-value structure.

As a result of the flattening and symbolization, keys-values may be recorded in a single level in the second configuration file.

The size of a file, obtained by flattening a nested structure of the first configuration file, may be bigger than the size of the first configuration file and the size of the first configuration file may be bigger than the size of the second configuration file.

The first configuration file may have a form of a manifest file.

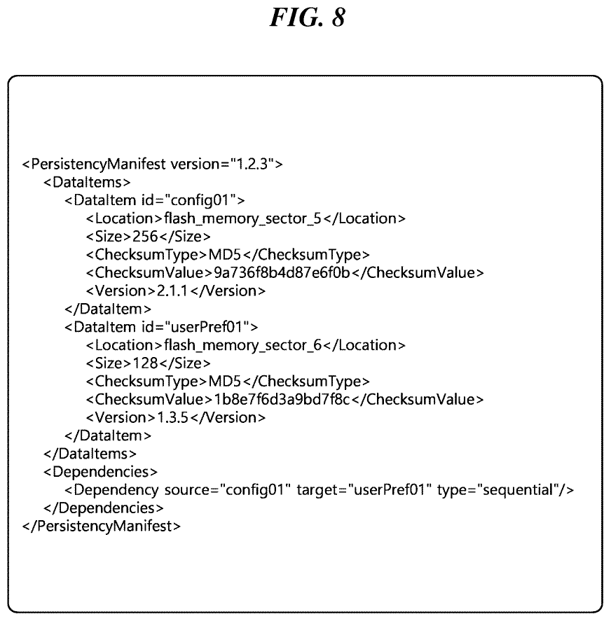

FIG. 8 is a diagram of a first configuration file according to an embodiment.

In the example in FIG. 8, <PersistencyManifest> indicates the entire manifest file. <DataItems> indicates a set of individual data items to be stored.

Each <DataItem> includes an ID, a storing place, the size, a type and a value of a checksum of data, and meta data, such as a version of the relevant data. A <Dependencies> section indicates the dependencies between data items. For example, this section indicates that config01 data needs to be processed in advance of userPref01 data.

Referring again to FIG. 7, the persistency module 730 may manage the persistency of data using such a configuration file, for example, a configuration file such as a manifest file.

The persistency module 730 may search for a key-value for one piece of data among the data in the second configuration file and may store the one-piece of data in the flash memory 750 based on a searched value.

The persistency module 730 may periodically store such one piece of data in the flash memory 750.

The persistency module 730 may store such one piece of data in the flash memory 750 before power is turned off.

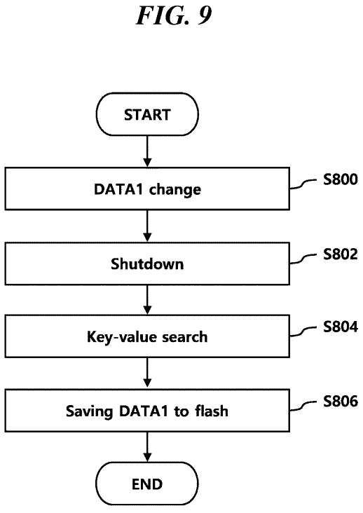

FIG. 9 is a diagram showing a process of storing data in a flash memory when power is turned off, according to an embodiment.

Referring to FIG. 9, one piece of data among data may be changed in an operation or step S800.

In addition, a signal indicating that power is turned off may be generated in an operation or step S802.

Subsequently, the persistency module may search for a key-value for this one piece of data in the second configuration file stored in the RAM in an operation or step S804.

The persistency module may store the one piece of data in the flash memory based on a searched value.

Time allowed for the generation of a signal indicating the power-off and the storage of data in the flash memory based on the searched data may be short. In order to perform such a process in a short time, the electronic control unit may flatten the first configuration file, simplify the same using the schema table, and store it as the second configuration file. The second configuration file, which is obtained by flattening and has a small data size, may shorten read/write time of the electronic control unit.

As described above, embodiments of the present disclosure allow reducing overhead of an electronic control unit and improving the performance of an electronic control unit. Embodiments of the present disclosure further allow enhancing the read/write performance of a configuration file storing keys-values in a nested structure.

Since terms, such as “including,” “comprising,” and “having” mean that corresponding elements may exist unless they are specifically described to the contrary, it should be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although example embodiments of the present disclosure have been described for illustrative purposes, those having ordinary skill in the art should appreciate that various modifications, additions, and substitutions are possible without departing from the scope and spirit of the present disclosure. Therefore, the embodiments described in the present disclosure are intended to illustrate the scope of the technical idea of the present disclosure, and the scope of the present disclosure is not limited by the described embodiments. The scope of the present disclosure should be construed on the basis of the accompanying claims in such a manner that all of the technical ideas included within the scope equivalent to the claims are included in the present disclosure.

What is claimed is:

1. An automotive electronic control unit, comprising:
an application configured to:
flatten a nested structure of a first configuration file in which keys-values are recorded in a nested structure,
substitute flattened keys with symbols recorded in a schema table,
record the symbols in a second configuration file, and
search for a key-value in the second configuration file; and
a memory configured to store the schema table and the second configuration file.

2. The automotive electronic control unit of claim 1, wherein, in the first configuration file and the second configuration file, keys-values are expressed and recorded in JavaScript Object Notation (JSON).

3. The automotive electronic control unit of claim 1, wherein:
in the first configuration file, keys-values are recorded by being nested in a depth of N, wherein N is a natural number equal to or greater than 2; and
in the second configuration file, keys-values are recorded in a single level.

4. The automotive electronic control unit of claim 1, wherein, in the schema table, matching relations between at least some keys recorded in the first configuration file and the symbols are defined.

5. The automotive electronic control unit of claim 1, wherein the symbols have a data size less than a data size of the key-values recorded in the first configuration file.

6. The automotive electronic control unit of claim 1, wherein the first configuration file is a manifest file.

7. An automotive electronic control unit, comprising:
a configuration module configured to:
flatten a nested structure of a first configuration file in which keys-values are recorded in a nested structure,
substitute flattened keys with symbols recorded in a schema table, and
record the symbols in a second configuration file;
a main module configured to perform a specific function and to change values of data stored in a random access memory (RAM) in accordance with the performance of the specific function; and
a persistency module configured to
search for a key-value for a piece of data among data in the second configuration file, and
store the piece of data in a flash memory based on the key-value.

8. The automotive electronic control unit of claim 7, wherein, in the second configuration file, at least one of a sector number, a size, or a checksum value of the flash memory is stored in a key-value structure.

9. The automotive electronic control unit of claim 7, wherein, in the second configuration file, keys-values are recorded in a single level.

10. The automotive electronic control unit of claim 7, wherein the persistency module is configured to store the piece of data in the flash memory before power is turned off.

11. The automotive electronic control unit of claim 7, wherein the persistency module is configured to periodically store the piece of data in the flash memory.

12. The automotive electronic control unit of claim 7, wherein:
a size of a file obtained by flattening a nested structure of the first configuration file is greater than a size of the first configuration file; and
the size of the first configuration file is greater than a size of the second configuration file.

13. The automotive electronic control unit of claim 7, wherein the first configuration file has a form of a manifest file.

14. An automotive electronic control method, comprising:
flattening a nested structure of a first configuration file in which keys-values are recorded in a nested structure;
substituting flattened keys with symbols recorded in a schema table;
recording the symbols in a second configuration file; and
searching for keys-values in the second configuration file.

15. The automotive electronic control method of claim 14, wherein searching for keys-values in the second configuration file includes searching for a key-value for one piece of data, among data stored in a random access memory (RAM), in the second configuration file and storing the one piece of data in a flash memory based on a searched value.

16. The automotive electronic control method of claim 15, further comprising generating a signal to indicate power off before storing the one piece of data in the flash memory.

17. The automotive electronic control method of claim 15, further comprising periodically generating signals by a timer before storing the one piece of data in a flash memory.

18. The automotive electronic control method of claim 14, wherein, in the first configuration file and the second configuration file, keys-values are expressed and recorded in JavaScript Object Notation (JSON).

19. The automotive electronic control method of claim 14, wherein:
in the first configuration file, keys-values are recorded by being nested in a depth of N, wherein N is a natural number equal to or greater than 2; and
in the second configuration file, keys-values are recorded in a single level.

20. The automotive electronic control method of claim 15, wherein, in the second configuration file, at least one of a sector number, a size, or a checksum value of the flash memory is stored in a key-value structure.
